(19) United States
(12) Patent Application Publication
(10) Pub. No.: US 2005/0011819 A1
(43) Pub. Date: Jan. 20, 2005

(54) Static pool skimmer

(76) Inventors: Patrick Gillen, Baton Rouge, LA (US); Roberto Sandoval, Baton Rouge, LA (US)

Correspondence Address: Steven Thrasher, 391 Sandhill Dr., Richardson, TX, 75080, US

(21) Appl. No.: 10/619,273

(22) Filed: Jul. 14, 2003

(51) Int. Cl. B01D 17/00

(52) U.S. Cl. 210/121; 210/169; 210/242.1; 210/523; 15/1.7

(57) ABSTRACT

The invention is a static pool skimmer for collecting surface debris from a In a preferred embodiment, the static pool skimmer is adapted to attach to a swimming pool railing and float on the surface of the water, collecting surface debris carried by a current.

### TECHNICAL FIELD

The invention relates to swimming pools, and, more particularly, the invention relates to swimming pool skimmers.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art

Discussion

Swimming is a popular recreational activity. Some prefer to swim in the privacy of their own backyard or with others at a community swimming pool. Two types of swimming pools can generally be defined: above-ground swimming pools and in-ground swimming pools.

Unfortunately, keeping swimming pools clean and clear of unwanted debris is an ongoing task. Swimming or wading in water filled with debris such as twigs, leaves, and bugs, can be an unpleasant and unsanitary experience. In more severe instances, organic debris may lead to growth and spread of disease within a swimming pool. Accordingly, there is needed a device that reliably and effectively eliminates swimming pool debris.

SELECTED OVER VIEW OF SELECTED EMBODIMENTS

This invention provides technical advantages as a static pool skimmer that collects surface debris from a swimming pool, thereby reducing unpleasant swimming and/or wading experiences. In addition, by collecting surface debris the growth and spread of disease within a swimming pool is decreased. Preferably, the static pool skimmer is adapted to attach to a swimming pool railing and float on the surface of the water, collecting surface debris carried by a current.

The static pool skimmer comprises a mounting portion, a collecting portion, a coupling means, and a debris directing means. The mounting portion is adapted to attach to a swimming pool railing. The collecting portion is enabled to collect unwanted debris from a swimming pool surface and comprises a floating member and a collecting means. The floating member enables the collecting portion to float on the surface of the water, while the collecting means gathers debris from the surface of the water. The mounting portion is coupled to the collecting portion via the coupling means. The debris directing means is adapted to prevent debris from ‘escaping’ the collecting means between the collecting portion and the inner wall of the swimming pool. Accordingly, in a preferred embodiment, the debris directing means is a flap that is adapted to attach to the collecting portion and extend to the interior wall of the swimming pool. In an alternative embodiment, the debris directing means may be integrally formed in the collecting portion, and alternatively may be adjustable.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates a static pool skimmer;

FIG. 2 illustrates a cross section of a static pool skimmer; and

FIG. 3 illustrates a preferred embodiment of a static pool skimmer.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for —functioning—” in the claims section.

Discussion of the Figures

The invention can be characterized as a static pool skimmer for collecting surface debris from a backyard or community swimming pool. In a preferred embodiment, the static pool skimmer is adapted to attach to a swimming pool railing and float on the surface of the water so that it collects surface debris carried by a current. One embodiment is adapted to attach to an aboveground pool, while an alternative embodiment is adapted to mount to an in-ground pool.

Features and advantages of the invention can be better understood by reviewing FIG. 1, which illustrates a static pool skimmer 100 for collecting surface debris 102 from swimming pool water 104. The static pool skimmer 100 comprises a mounting portion 110, a collecting portion 120, a coupling means 130, and a debris directing means 140. In a preferred embodiment, the static pool skimmer 100 is assembled from different size pipes, which could be plastic, PVC, metal, or wood, for example. In alternative embodiments, the static pool skimmer 100 may be a single piece of plastic, or assembled from hollow tubes, for example, and a collecting means 122, such as a net.

The mounting potion 110 is adapted to attach to a pool railing 106. In a preferred embodiment, the mounting portion 110 has a mounting member 112 that may be adjusted to the width of the pool railing 106 by using tubes of different diameters, securing the tubes in place with a bolt or other device that is well known in the art. In alternative embodiments, the mounting member 112 may be a fixed size or shape, and either “snap” or slide into place on the railing. The mounting portion 110 is adapted to couple to the collecting portion 120 via a coupling means 130. In a preferred embodiment, the coupling means 130 is a hollow tube, but could also be a hollow barrel, clasp, or clamp, in alternative embodiments.

The collecting portion 120 is adapted to collect surface debris 102 from swimming pool water 104. The collecting portion 120 generally comprises a collecting means 122, a flotation member 124, a lower front arm 125, an upper back arm 126, and a side arm 127. In a preferred embodiment, the collecting means 122 is a nylon net that is removably attached as is well known in the art. In alternative embodiments, the collecting means 122 may be any removably attached or integrally formed means to collect surface debris 102 from swimming pool water 104 such as a twine net, single-form strainer, wire mesh, or polyurethane array of fibers, for example.

The flotation member 124 enables the collecting means 122 and the upper back arm 125 to float at least on or just out of the surface of the swimming pool water 104 in a buoyant position that preferably places the collecting means across the surface of the water (the upper back arm 126 is out of the water and the lower front arm 125 is in the water). In a preferred embodiment, the flotation member 124 is a roll of polyurethane foam that is adapted to attach to the side arm 127. In alternative embodiment, the floatation member 124 may be any material or device that enables the collection means 122 to float on the surface of the swimming pool water 104 such as wood, a buoy, or air inflatable tube. Furthermore, the roll of polyurethane foam may be adapted to attach to the lower front arm 125 or the upper back arm 126, for example. Of course, if a polyurethane foam or other foam is chosen, the foam should at least be neutrally buoyant, or sink.

The flotation member 124 maintains the buoyancy of the collecting portion 120 and enables the collecting means 122 to gather debris 102. In a preferred embodiment, the lower front arm 125 remains buoyant slightly below the surface of the water. The upper back arm 126 remains slightly buoyant above the surface of the water. In addition, the positioning of each arm orients the collecting means 122 so that the front most portion is slightly under the surface of the water and the rear most portion is slightly above the surface of the water. Furthermore, the debris directing means 140 upper most portion will remain above the surface of the water, whereas, the lower most portion will remain below the surface of the water.

The debris directing means 140 is enabled to prevent surface debris 102 from ‘escaping’ the collecting means 120 by preventing debris 102 from passing between the collecting portion 120 and the inner pool wall 108. This is particularly a problem in above ground pools where the centrifugal force of the water current “throws” heavy debris to edge of the interior wall of the swimming pool. In a preferred embodiment, the debris directing means 140 is a removably attached flap that is enabled to attach to the collecting portion 120. Furthermore, the debris directing means 140 is adjustable to any space between the collecting portion 120 and the interior pool wall 108. In alternative embodiment, the debris directing means 140 may be integrally formed within the collecting portion 120 and may also include a collecting means 122. In another alternative embodiment, the debris directing means 140 may comprise an orifice and a collecting means 122 that is adapted to attach to the perimeter of the orifice.

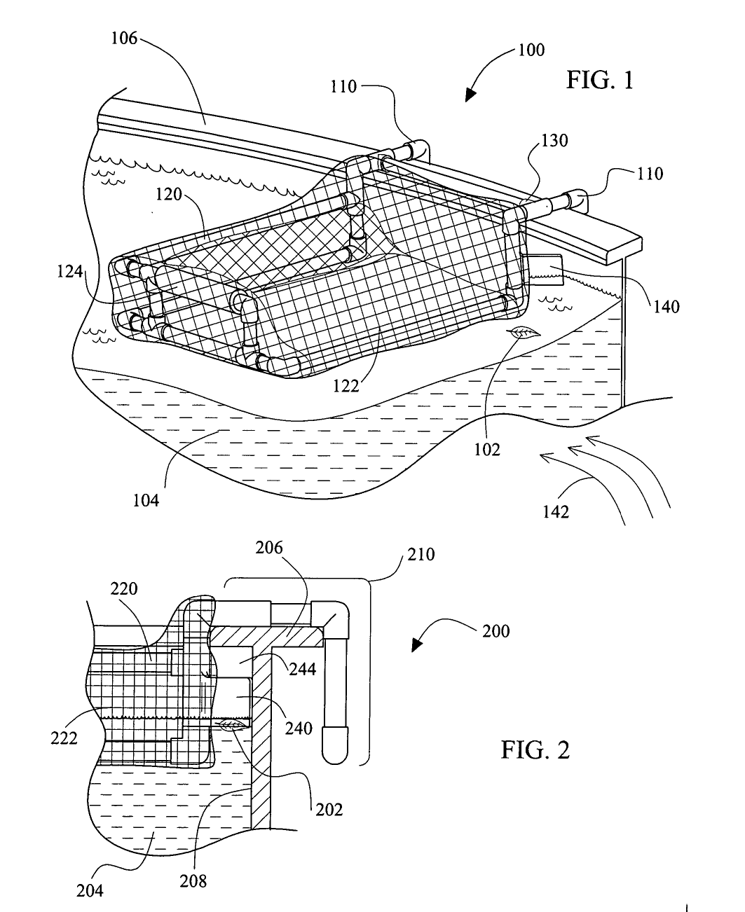

FIG. 2 illustrates a cross section of a static pool skimmer 200 attached to an above ground swimming pool. In a preferred embodiment, the static pool skimmer 200 is mounted to a pool railing 206 via the mounting portion 210 such that the collecting portion 220 may float on the surface of the water 204. Furthermore, the debris directing means 240 will removably attach to the collecting portion 220 and extend from the collecting portion 220 most near the interior pool wall 208 to the interior pool wall 208 preventing debris 202 from ‘escaping’ the collecting means 222 and passing into the debris void 244. The debris directing means 240 will be adjustable. In alternative embodiments, the debris directing means 240 may be integrally formed within the collecting portion 220. In addition, these embodiments may also provide a means for adjusting the debris directing means 240 to prevent debris 202 from ‘escaping’ the collection means 220 and passing into the debris void 244.

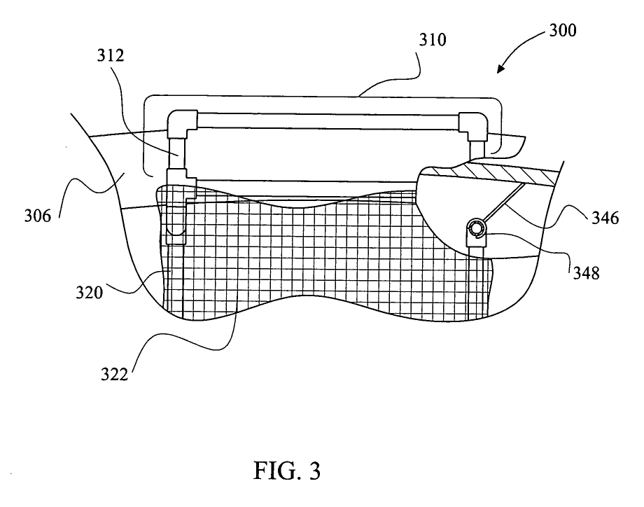

FIG. 3 is a preferred embodiment of a static pool skimmer 300. The static pool skimmer 300 has a mounting portion 310 that comprises a mounting member 312 and comprises hollow tubes. The mounting member 312 is adjustable to the size of the pool railing 306 which is preferably between 7 inches and 12 inches. In addition, the collecting portion 320 is less than 24 inches long and less than 20 inches wide. The collecting portion 320 comprises hollow tubes. The collecting means 322 is a removably attached net comprised of nylon. Furthermore, the debris directing means 340 is a flap having a debris directing member 346 and a securing portion 348. The debris directing member 346 is less than 5 inches long and 5 inches tall. The debris directing member 346 is made of plastic.

Of course, it would be readily apparent to those of ordinary skill in the art that alternative embodiments may include suspending the debris directing means from the mounting portion, or attaching the debris directing means to the inner pool wall via a suction cup, for example, may also accomplish debris from bypassing the collecting means. In additional, it is also apparent that the static pool skimmer and any or all portions may be made of materials, or in different dimensions other than those described.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

1. A static pool skimmer, comprising:
a mounting portion;
a collecting portion;
a coupling means adapted to couple the mounting portion to the collecting portion; and
a debris directing means.

2. The static pool skimmer of claim 1 whereby the mounting portion is adapted to attach to a portion of an above-ground swimming pool railing.

3. The static pool skimmer of claim 1 whereby the mounting portion is adapted to mount to a portion of an in-ground swimming pool railing.

4. The static pool skimmer of claim 1 whereby the collecting portion comprises a collecting means, a flotation member, an upper back arm, a lower front arm, and a side arm.

5. The static pool skimmer of claim 4 wherein the collecting means is a net.

6. The static pool skimmer of claim 4 wherein the flotation member is a piece of polyurethane foam.

7. The static pool skimmer of claim 1 whereby the debris directing means is adapted to removably attach to the collecting portion.

8. The static pool skimmer of claim 1 wherein the debris directing means is integrally formed within the collecting portion.

9. The static pool skimmer of claim 1 wherein the debris directing means comprises an orifice and a collecting means that is adapted to attach to the perimeter of the orifice.

10. A static pool skimmer, comprising:
a mounting portion having a mounting member, the mounting portion enabled to attach to a swimming pool railing portion;
a collecting portion having a collecting means and a flotation member;
a coupling means adapted to couple the mounting portion to the collecting portion; and
a debris directing means having a securing portion and a debris directing member, whereby the securing portion is adapted to attach to the collecting portion and, the debris directing member is enabled to prevent debris passing between the collecting portion and an inner swimming pool wall.

11. The static pool skimmer of claim 10 whereby the collecting portion comprises a lower front arm, an upper back arm, and a side arm adapted to orient the debris directing means such that the upper most portion is above the surface of the water and the lower most portion is below the surface of the water, thus preventing debris from escaping the collecting means.

12. The static pool skimmer of claim 10 whereby the mounting portion comprises an adjustable mounting member.

13. The static pool skimmer of claim 11 whereby the mounting portion comprises hollow tubing.

14. The static pool skimmer of claim 11 whereby the collecting portion comprises hollow tubing.

15. The static pool skimmer of claim 11 whereby the coupling means comprises hollow tubing.

16. The static pool skimmer of claim 11 whereby the collecting means is adapted to removably attach to the collecting portion.

17. A static pool skimmer, comprising:
a mounting portion having an mounting member, the mounting portion enabled to attach to a swimming pool railing portion;
a collecting portion having a collecting means, a flotation member, a lower front portion, an upper back portion, and a side portion;
a coupling means adapted to couple the mounting portion to the collecting portion; and
a debris directing means having a securing portion and a debris directing member, whereby the securing portion is a clip adapted to attach to the collecting portion, and the debris directing member is a flap enabled to prevent debris passing between the collecting portion and an inner swimming pool wall.

18. The static pool skimmer of claim 17 whereby the mounting member is adapted to be adjusted between 7 inches and 12 inches.

19. The static pool skimmer of claim 17 whereby the collecting portion is less than 24 inches long and less than 20 inches wide.

20. The static pool skimmer of claim 17 whereby the flap is less than 5 inches long and less than 3 inches high.
